(19) United States
(12) Patent Application Publication
(10) Pub. No.: US 2010/0124905 A1
(43) Pub. Date: May 20, 2010

(54) Systems and Methods for Message Forwarding

(75) Inventors: James Pratt, Round Rock, TX (US); Derik Mortlock, Renton, WA (US); Marc Sullivan, Austin, TX (US)

Correspondence Address: AT&T Legal Department - WW, Patent Docketing Room 2A-207, One AT&T Way, Bedminster, NJ, 07921, US

(73) Assignee: AT&T Mobility II LLC, Atlanta, GA (US)

(21) Appl. No.: 12/270,916

(22) Filed: Nov. 14, 2008

(51) Int. Cl. H04L 12/58

(52) U.S. Cl. 455/412.1

(57) ABSTRACT

Methods and systems for forwarding messages are disclosed. A device, component, or subsystem of a device or network may evaluate a recipient number in a message and determine that the recipient number is not associated with a device capable of receiving the message. An alternate recipient number may be selected and the message transmitted to the alternate recipient number. The evaluation and assignment of an alternate number may be performed on a mobile device, network equipment, or third party devices. In one alternative, a message is sent to a recipient number and a failure message is received. An alternate number may then be selected and the message sent to the alternate number. Alternate numbers may be selected from numbers available in an address book, in network configuration parameters, or from user preferences.

### CROSS-REFERENCE TO RELATED APPLICATIONS

This application is related by subject matter to U.S. patent application Ser. No. 11/549,382 filed on Oct. 13, 2006, entitled “METHOD AND APPARATUS FOR NOTIFYING AN END USER OF A MESSAGING EVENT IN A MULTI-USER SETTING”, and U.S. patent application Ser. No. 12/054,271 filed on Mar. 24, 2008, entitled “INTELLIGENT FORWARDING OF SHORT MESSAGE SERVICE AND MULTIMEDIA MESSAGING SERVICE MESSAGES”.

### BACKGROUND

Short message service (SMS) and multimedia messaging service (MMS) are communication protocols that allow users to transmit short text messages and messages that include multimedia objects to mobile devices. As mobile devices become more prevalent, more and more people will rely on SMS and MMS services to exchange information. With more and more people using these services, and with the proliferation of mobile devices, it is likely that users of mobile devices will have increasingly large address books on the devices, and multiple numbers for people listed in their address books. There are situations where a user will select a name out of an address book as a recipient of a message, and the name will be associated with a number that does not support messaging services. In other situations, a user will select a number from among several listed for a recipient, and attempt to transmit a message to a device that does not support messaging services. In these and other situations there exists a need to improve SMS/MMS forwarding techniques.

### SUMMARY

Systems and methods are provided herein for detecting a selection of a recipient or recipient number for the message on a device, determining that the recipient or number is associated with a device that does not support messaging, determining an alternate recipient or number, and transmitting the message to the alternate recipient number. The device may be a mobile device of any kind, or any other device capable of receiving input for messaging. The types of messages that may be sent include text messages, SMS/MMS messages, email, or any other type of message.

Detection of an invalid messaging recipient or number may be performed on the user device, on network equipment, or on third party equipment. The number or recipient may be checked before the message is sent to determine if it is associated with a device that is capable of receiving the message. Alternatively, failure messages may be detected, and an alternate recipient or number may be selected upon detection of the failure message. Message types may also be evaluated, and messages may be forwarded to devices capable of receiving the particular message type.

Messaging capable devices may be indicated by the user, for example when the user enters a recipient into an address book, or by the network or a third party. The capabilities of a recipient device may be determined according to a network services plan or a specific device as known by a network operator or third party. Various other permutations and embodiments are described herein and/or contemplated.

These and other features and advantages of various exemplary embodiments of systems and methods according to this disclosure are described in, or are apparent from, the following detailed description of various exemplary embodiments of the systems and methods of this subject matter.

### BRIEF DESCRIPTION OF THE DRAWINGS

Various exemplary embodiments of this invention will be described in detail, with reference to the following figures, wherein like numerals represent like elements, and wherein:

FIG. 1 is a block diagram of a non-limiting, exemplary wireless device, wireless network, and address book system and interface.

FIG. 2 is a flow chart of a non-limiting, exemplary method of selecting an alternate destination number for a message.

FIG. 3 is a flow chart of a non-limiting, exemplary method of selecting an alternate destination number for a message.

FIG. 4 is a block diagram of a non-limiting, exemplary wireless device that may be used in connection with an embodiment.

FIG. 5 is a block diagram of a non-limiting, exemplary processor in which the present subject matter may be implemented.

FIG. 6 is an overall block diagram of an exemplary packet-based mobile cellular network environment, such as a GPRS network, in which the present subject matter may be implemented.

FIG. 7 illustrates a non-limiting, exemplary architecture of a typical GPRS network as segmented into four groups.

FIG. 8 illustrates a non-limiting alternate block diagram of an exemplary GSM/GPRS/IP multimedia network architecture in which the present subject matter may be implemented.

### DETAILED DESCRIPTION OF ILLUSTRATIVE EMBODIMENTS

Modern communications devices allow people to communicate with one another through many different channels. Standard telephones, work telephones, mobile telephones and other mobile devices, and the various types of computers and computing devices provide a plethora of communications options to the average person. With the cost of obtaining and using such devices continuing to decrease, the communications options available will expand even further. However, this can create a problem when a user needs to select which channel of communications to use to communicate with another person.

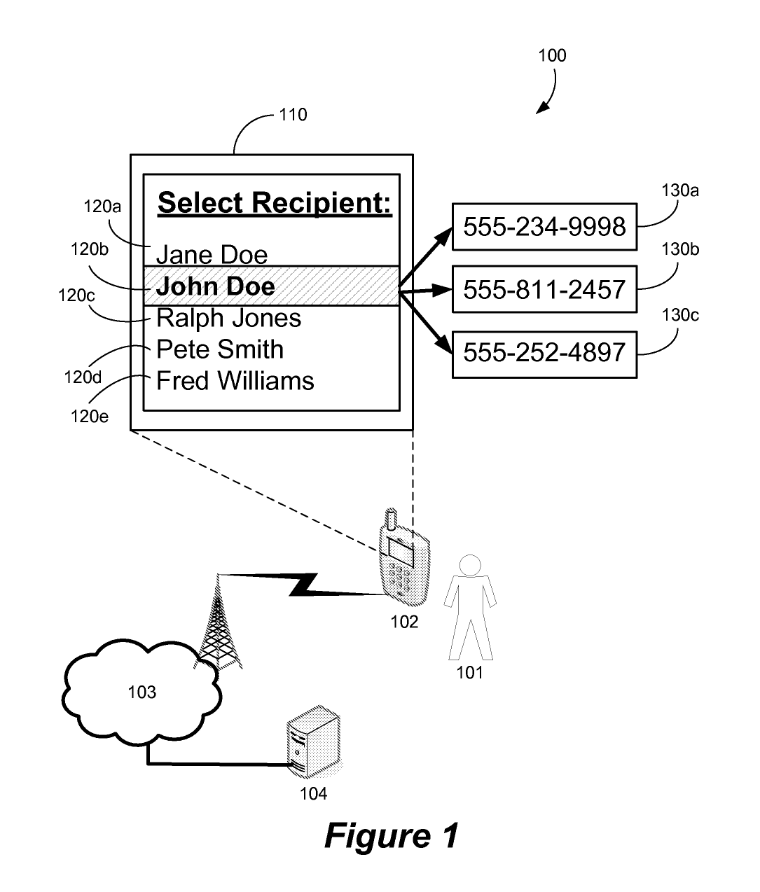

FIG. 1 illustrates a system 100 including devices, a network, and an address book that a user may operate when attempting to communicate a message to a recipient. When user 101 desires to send a message to a recipient, such as a short message service (SMS) message or a multimedia messaging service (MMS), user 101 may operate device 102 that has a display 110. Device 102 may be any device operable by a user, including a mobile telephone, personal data assistant (PDA), laptop or desktop computer, or any other type of device. Device 102 may communicate with other devices, such as device 104, using network 103. Device 104 may be a component, system, or subsystem of network 103, or device 104 may be owned, operated, and/or under the control of a third party. Network 103 may be any network capable of facilitating communication between two or more devices, including a wireless network.

At some point in the process of composing and sending a message to a recipient, user 101 will have to enter a destination number of a recipient or select the recipient and/or the recipients number from a list. Often a messaging user will select a recipient from an address book. An address book may be stored on device 102, on equipment within network 103, or on device 104, and may be accessible through the operation of device 102. Device 104 may be owned, operated, and/or under the control of a third party or the operator of network 103. The address book may list recipients by name, such as recipients 120a-e shown in display 110. User 101 may select a recipient from the list, such as recipient 120b. Recipient 120b may have several numbers associated with him or her. For example, John Doe (recipient 120b) may have a work telephone number 130a, a home telephone number 130b, and a mobile device number 130c associated with his name in user's 101 address book.

It may be that only mobile device number 130c is associated with a device that is capable of receiving messages such as that which user 101 is intending to send to recipient 120b. However, user 101 may not remember or know which of the numbers listed for recipient 120b in the address book is the number associated with a device capable of receiving the intended message. Therefore, user 101 may select a number, such as work telephone number 130a, as the recipient number for the message, and the message may then fail. An error message may be returned to device 102 from network 103. Alternatively, the message may simply fail to be delivered, and user 101 may never learn of the failure.

In some embodiments, a user may select only a name, and a default number may be used by device 102. For example, user 101 may select recipient 120b, and device 102 may be configured to use work telephone number 130a by default. Work telephone number 130a may not be associated with a device that is capable of receiving certain types of messages. Thus, when user 101 selects recipient 120b to receive a message, the message may be sent to work telephone number 130a, and fail.

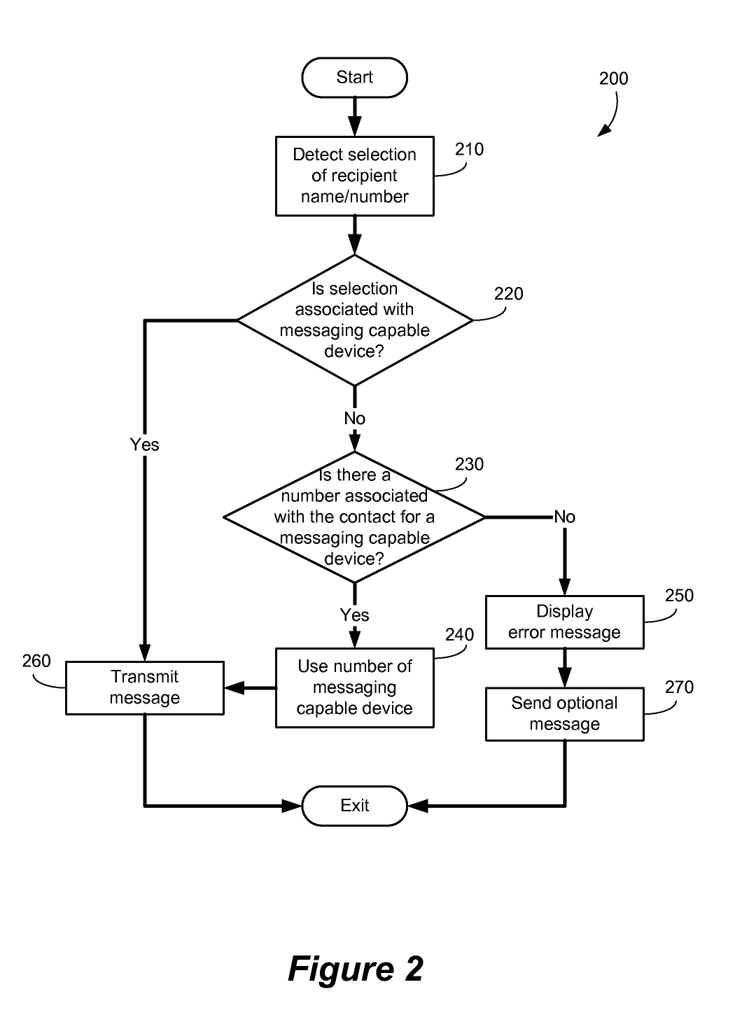

FIG. 2 illustrates a non-limiting, exemplary method 200 of selecting a destination number for a message that is intended to be sent to a recipient. Method 200 may be implemented on any device that may be capable of sending a message of any type, including SMS MMS messages. Alternatively, method 200 may be implemented on network equipment that is in communication with a device operated by a user. In another alternative, method 200 may be implemented on third party equipment that is accessible by a user through the operation of a device communicating over a network. All such embodiments and combinations thereof are contemplated as within the scope of the present disclosure.

At block 210, the user of the device selects a recipient. This may be the selection of a recipient's name from an address book stored on the device, or it may be the selection of a particular number that may be associated with a contact in an address book stored on the device. Alternatively, the address book may be stored on network equipment and accessible by using the device, or downloaded to the device from network equipment. In yet another alternative, the address book may be maintained by a third party provider, and accessible on the device through a network. For example, the address book may be accessible on a webpage which is viewed on a web browser configured on the device. All such configurations and any other configuration that allows access to an address book on a device are contemplated as within the scope of the present disclosure.

At block 220, a determination is made as to whether the selected name or number is associated with a messaging capable device. This determination may be made on the device itself, on network equipment, on third party equipment, or on any other system or subsystem. This determination may also be made at any time where it is useful. For example, where method 200 is partially or entirely implemented on network provider equipment, the network provider equipment, such as a home location register (HLR) or any other network device, system, or subsystem, may make the determination. The device operated by the user may compose the message and transmit it to the network. The network equipment may examine the message transmission, extract the destination number, and determine that the destination number is a land line number that is traditionally associated with devices that are not capable of receiving SMS or MMS messages or the like.

Alternatively, the network equipment may determine that the destination number is associated with a mobile device that is commonly capable of receiving messages of the type to be sent, and, at block 260, process and transmit the message. In still another alternative, the network equipment may determine that the destination number is associated with a device capable of receiving messages of the type to be sent, but that the subscriber of that device has not paid for a messaging service, and therefore the device is not in fact capable of receiving the message. Any other combinations and determinations of device and recipient capability are contemplated.

In another alternative, the determination may be made based on data received on the device or elsewhere when the contact information was configured in the address book. For example, at some point while configuring a number for the contact in the address book, whether the address book is stored on the user's device, the network, or in a third party system or subsystem, the user may have marked, selected, or otherwise indicated whether the number is associated with a device that is capable of receiving messages. Alternatively, or in addition, the user may have indicated that one number associated with a contact is to be used for all messages, or for messages of a certain type, format, protocol, etc. The user may also have indicated that a second number is to be used as a fall-back number in the event that messages to the preferred messaging number fail, and that a third number is to be used if messages to the second number fail, etc. Any such configuration capabilities may be provided by a device, network equipment, or third party equipment that may be used to maintain and operate an address book.

Note that the determination at block 230 may also evaluate the types of messages sent. For example, one number for a contact in an address book may be associated with a device that is capable of receiving only SMS messages, while another number for that contact may be associated with a device that is capable of receiving both SMS and MMS messages. Thus, the determination may be made that an MMS message is being sent and a non-MMS number has been selected.

If it is determined at block 220 that the selected number is associated with a device that is capable of receiving the type of message that the user is attempting to send, then, at block 260, the message is transmitted.

On the other hand, if at block 220 it is determined that the selected number is not capable receiving the type of message that the user is attempting to send, then at block 230, a determination is made as to whether there is a number associated with the contact that is capable of receiving the type of message that is to be sent. For example, if a contact name is selected from the address book as the recipient, and it is determined at block 220 that the default number associated with that contact name is associated with a device that is not capable of receiving the type of message that is to be sent, then the other numbers associated with that contact name may be checked to determine if any are associated with a device that is capable of receiving the type of message to be sent. If multiple numbers are available to receive that type of message, the first listed may be selected, or they may be prioritized as described herein, and the highest priority number may be user.

Alternatively, if a contact number is selected, and it is determined at block 220 that the selected number is associated with a device that is not capable of receiving the message, then the contact name associated with the number may be determined. Any other numbers associated with that contact name may be evaluated to determine if any of them are associated with devices capable of receiving the message. For example, if the message is received at a piece of network equipment or other subsystem, and the destination number is determined to be a land line number, then the network subsystem may determine the contact name associated with the destination number, locate a mobile device number associated with that contact, and change the destination number to that of the mobile device or otherwise transmit the message to the mobile device number at block 260.

In one embodiment, rather than through an address book, associated numbers may be determined by a network provider based on bundled services. For example, a single provider may provide both mobile and land line telephony services for a recipient. When the provider receives a message with a destination number associated with the recipients land line telephone number, the provider may perform a look-up in a database or use other means to determine that the recipient also has a mobile device serviced by the provider. The provider may then alter the message transmission by changing the destination number to that of the mobile device.

Alternatively, a recipient may set up a preference with the provider that all messages of a certain type, or all types, are to be transmitted to one particular number, or via an alternate method, regardless of the number provided by the sender of such messages. For example, a recipient may request that all messages are converted to email and sent to an email account. Alternatively, all messages may be configured to be sent to a particular mobile device. In a variation of this embodiment, a land line customer may request, in one alternative for a fee, that any messages transmitted to the number associated with the customer's land line, be transmitted to a number that is associated with a device serviced by a different carrier. In this embodiment, the land line carrier or network provider may intercept messages destined for the land line number and redirect them to the number specified by the customer for another device.

Once an alternative number is determined, the message is constructed using the alternative number at block 240. Alternatively, the message may have already been constructed, such as when the message is received at a network device or subsystem before the determinations of blocks 220 and 230, and the alternative number determined in block 230 may be put into the message by the network equipment in place of the original number at block 240. Other permutations of setting or substituting the alternative number for the original are contemplated. The message is then transmitted at block 260.

If, at block 230, it is determined that there is no number associated with the contact for a device that is messaging capable, then an error message may be displayed at block 250. This message may be displayed at the device as a result of the device performing the determination at block 230, or it may be displayed at the device in response to a message or command from network or third party devices, equipment, and/or subsystems. Any means and methods for generating, displaying, or otherwise causing an error message to be provided to a user are contemplated as within the scope of the present disclosure.

Optionally, at block 270, a message of another form may be transmitted to the recipient, the sender, or both. For example, the recipient may have an email address associated with him or her in the address book, the network provider records, or elsewhere. If a message fails, the message may be transmitted in an email, in one embodiment with other information indicating the failure of the original message, to the email address. Alternatively, a voice message may be generated, in one embodiment containing an audio version of the message, and transmitted to the original number or an alternate number. Alternatively, or in addition, an email or other type of message may be transmitted to the sender to let him or her know of the message transmission failure. Any other alternate type of message and contents of such a message are contemplated as within the scope of the present disclosure.

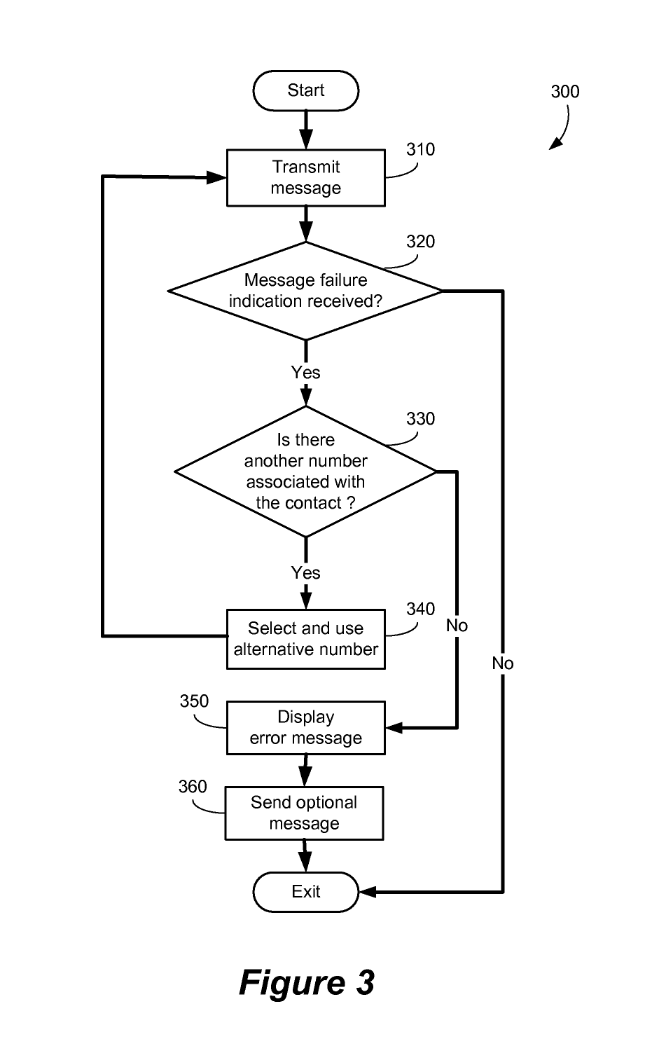

FIG. 3 illustrates an alternative non-limiting, exemplary method 300 of automatically selecting a number for a message recipient when an initial number fails. This method allows for the determination of alternative numbers to be performed only after a destination number fails to provide a path to a device that is capable of receiving the sent message. This may allow for more efficient use of resources in some circumstances.

At block 310, a message is transmitted from a device. This may be any sort of message, including MMS and SMS messages. At block 320, indications of a failure of the message transmission are detected and/or received. This may be any indication of message transmission failure, failure to deliver, error message, or the like. Such an indication may be received or detected at a device operated by a user, at a network device, equipment, system, or subsystem, or at a third party system or subsystem.

If no indication of message failure is received, then the method is complete. If at block 320 an indication of message failure is received, than at block 330 a determination is made as to whether there is an alternative number available for the intended recipient. As set forth herein in regard to FIG. 2, many means and methods are available to make this determination. The recipient name in an address book or account with a provider may be located based on the destination number and other numbers associated with the recipient may be derived from this information. Alternatively, as described in more detail in regard to FIG. 2, numbers may tagged, marked, or otherwise contain an indication that they are associated with a device that is capable of receiving the type of message originally sent. One of these such numbers may be selected from those available for a recipient. Alternatively, any available number associated with the recipient may be used. It is contemplated that the systems, subsystems, devices, and/or components performing this method or method 200 may keep one or more records or use one or more databases to track the numbers to which a particular message may have been sent. Such records or databases may store entire copies of the messages, or just the relevant information required to prevent duplicate message transmissions to the same number.

If no other numbers are available or known to be associated with the intended recipient, then an error message may be displayed to the user at block 350. This message may be generated or otherwise created on a device operated by the user, or may be generated as a result of a command sent to the device from the network or a third party. As with FIG. 2, all such error message generation means and methods are contemplated as within the scope of the present disclosure. Also as described with regard to FIG. 2, at block 360 an alternate message may be transmitted to the intended recipient and/or the sender via email, voice, etc.

If an alternate number or numbers are located or determined at block 330, then at block 340 a number is selected. As indicated above, the number may be selected due to a characteristic, such as a number being associated with a mobile device typically capable of receiving messages or part of a messaging plan paid for by a recipient. Alternatively, a number may be selected because it is marked as being associated with a device that is capable of receiving messages. In yet another alternative, it may be most efficient for a system or subsystem to select alternate numbers randomly, and record the use of each number. This may be useful in a situation where determining the capability of a recipient device associated with a particular number is expensive, but transmitting repeated messages and recording message transmission information is inexpensive. Any method or means of selecting an alternative number is contemplated as within the scope of the present disclosure. The message is then resent using the alternate number, returning to block 310.

Note that any of the methods, systems, and means described herein may be used for any type of message and with any technology. For example, rather than messages to telephone numbers, the methods recited herein may be applied to any messaging technology that includes addressable recipients, such as email and voice technology.

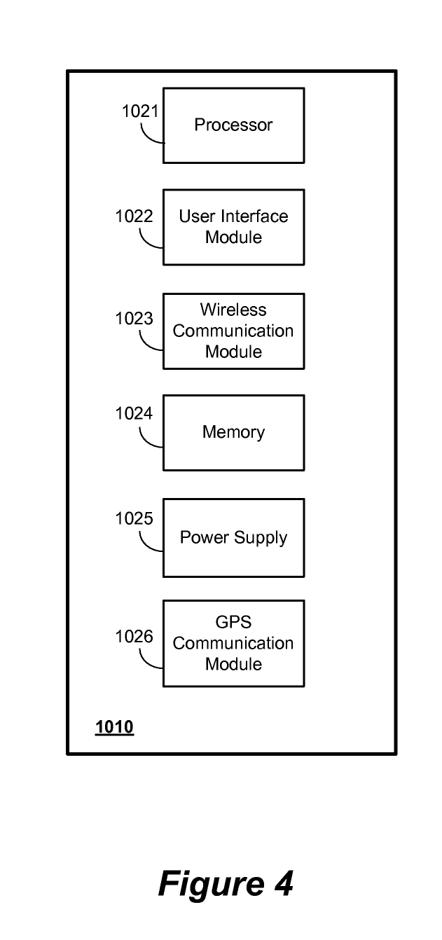

FIG. 4 illustrates an example wireless device 1010 that may be used in connection with an embodiment. References will also be made to other figures of the present disclosure as appropriate. For example, device 102 may be a wireless device of the type described in regard to FIG. 4, and may have some, all, or none of the components and modules described in regard to FIG. 4. It will be appreciated that the components and modules of wireless device 1010 illustrated in FIG. 4 are illustrative, and that any number and type of components and/or modules may be present in wireless device 1010. In addition, the functions performed by any or all of the components and modules illustrated in FIG. 4 may be performed by any number of physical components. Thus, it is possible that in some embodiments the functionality of more than one component and/or module illustrated in FIG. 4 may be performed by any number or types of hardware and/or software.

Processor 1021 may be any type of circuitry that performs operations on behalf of wireless device 1010. In one embodiment, processor 1021 executes software (i.e., computer readable instructions stored in a computer readable medium) that may include functionality related to constructing, transmitting, receiving messages such as SMS and MMS messages, operating an address book, and determining alternate addresses, for example. User interface module 1022 may be any type or combination of hardware and/or software that enables a user to operate and interact with wireless device 1010, in one embodiment, to compose and read messages. For example, user interface module 1022 may include a display, physical and “soft” keys, voice recognition software, microphone, speaker and the like. Wireless communication module 1023 may be any type or combination of hardware and/or software that enables wireless device 1010 to communicate with, for example, network 103 or any other type of wireless communications network. Memory 1024 enables wireless device 1010 to store information, such as an address book, contacts information, or the like. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010.

GPS communication module 1026 may be any type or combination of hardware and/or software that enables wireless device 1010 to communicate with GPS location equipment. In one embodiment, wireless communication module 1023 may perform the functions of GPS communication module 1026. In an alternative embodiment, GPS communication module 1026 may be separate from wireless communication module 1023.

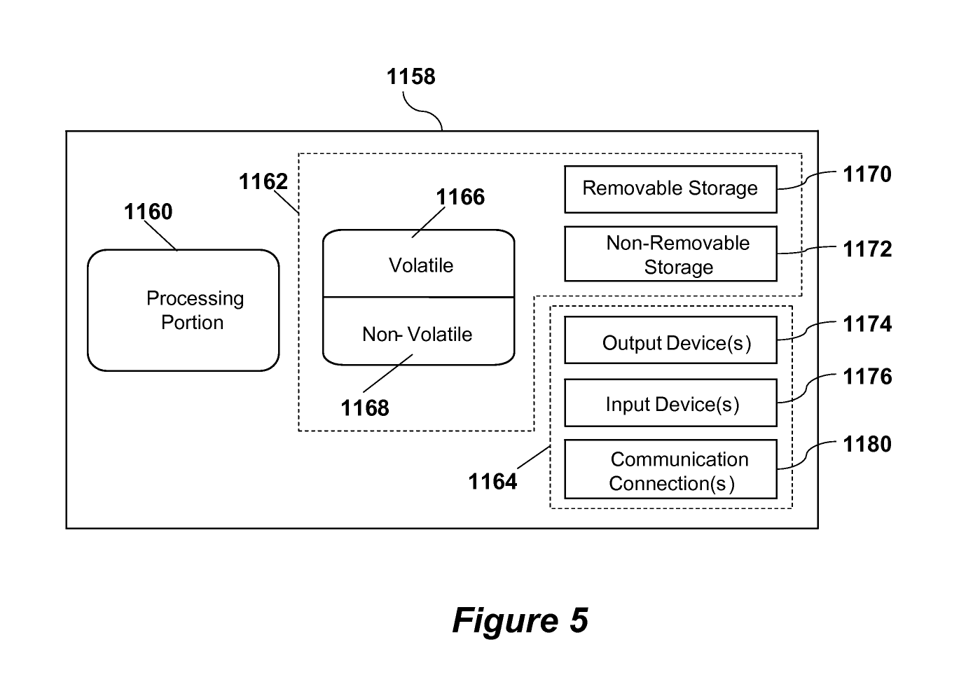

FIG. 5 is a block diagram of an example processor 1158 which may be employed in any of the embodiments described herein, including as one or more components of a communications device such as device 102 which may be a wireless communications device, as one or more components of communications network equipment or related equipment, such as any component of network 103, and/or as one or more components of any third party system or subsystems that may implement any portion of the subject matter described herein. It is emphasized that the block diagram depicted in FIG. 5 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof.

The processor 1158 comprises a processing portion 1160, a memory portion 1162, and an input/output portion 1164. The processing portion 560, memory portion 562, and input/output portion 1164 are coupled together (coupling not shown in FIG. 5) to allow communications between these portions. The input/output portion 1164 is capable of providing and/or receiving components utilized to, for example, transmit/receive messages and/or transmit/receive data for an address book or contact list.

The processor 1158 can be implemented as a client processor and/or a server processor. In a basic configuration, the processor 1158 may include at least one processing portion 1160 and memory portion 1162. The memory portion 1162 can store any information utilized in conjunction with transmitting, receiving, and/or processing messages, contact information and numbers, determining alternate contacts, etc. For example, as described above, the memory portion is capable of storing an address book and software capable of operating the address book and determining alternate numbers. Depending upon the exact configuration and type of processor, the memory portion 1162 can be volatile (such as RAM) 1166, non-volatile (such as ROM, flash memory, etc.) 1168, or a combination thereof. The processor 1158 can have additional features/functionality. For example, the processor 1158 can include additional storage (removable storage 1170 and/or non-removable storage 1172) including, but not limited to, magnetic or optical disks, tape, flash, smart cards or a combination thereof. Computer storage media, such as memory and storage elements 1162, 1170, 1172, 1166, and 1168, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 1158. Any such computer storage media may be part of the processor 1158.

The processor 1158 can also contain the communications connection(s) 1180 that allow the processor 1158 to communicate with other devices, for example through network 103. Communications connection(s) 1180 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer readable media as used herein includes both storage media and communication media. The processor 1158 also can have input device(s) 1176 such as keyboard, keypad, mouse, pen, voice input device, touch input device, etc. Output device(s) 1174 such as a display, speakers, printer, etc. also can be included.

Network 103 may comprise any appropriate telephony radio network, or any other type of communications network, or any combination thereof. The following description sets forth some exemplary telephony radio networks, such as the global system for mobile communications (GSM), and non-limiting operating environments. The below-described operating environments should be considered non-exhaustive, however, and thus the below-described network architectures merely show how IP cellular broadcast may be used with stationary and non-stationary network structures and architectures. It can be appreciated, however, that message forwarding systems such as those described herein can be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be extended to 3G services, such as Universal Mobile Telephone System (UMTS), Frequency Division Duplexing (FDD) and Time Division Duplexing (TDD), High Speed Packet Data Access (HSPDA), cdma2000 1× Evolution Data Optimized (EVDO), Code Division Multiple Access-2000 (cdma2000 3×), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4G Services such as Long Term Evolution (LTE), etc., as well as to other network services that become available in time. In this regard, the techniques of the utilization of SMS, MMS, and/or cellular broadcast can be applied independently of the method of data transport, and do not depend on any particular network architecture, or underlying protocols.

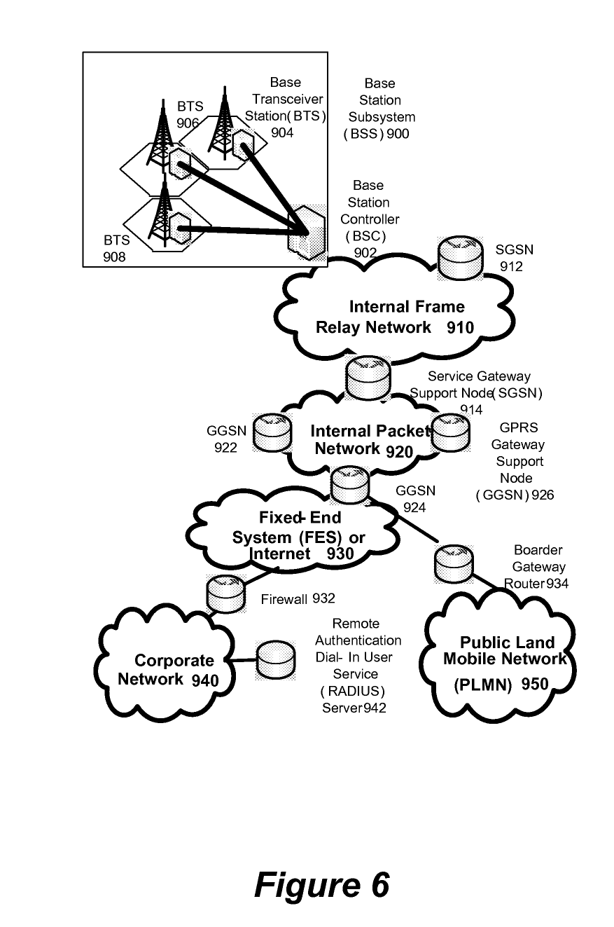

FIG. 6 depicts an overall block diagram of an exemplary packet-based mobile cellular network environment, such as a GPRS network, in which message forwarding systems such as those described herein can be practiced. In an example configuration, network 103 may be encompassed by the network environment depicted in FIG. 6. In such an environment, there may be a plurality of Base Station Subsystems (BSS) 900 (only one is shown), each of which comprises a Base Station Controller (BSC) 902 serving a plurality of Base Transceiver Stations (BTS) such as BTSs 904, 906, and 908. BTSs 904, 906, 908, etc. are the access points where users of packet-based mobile devices (e.g., device 102) become connected to the wireless network. In exemplary fashion, the packet traffic originating from user devices (e.g., device 102 and device 104) may be transported via an over-the-air interface to a BTS 908, and from the BTS 908 to the BSC 902. Base station subsystems, such as BSS 900, may be a part of internal frame relay network 910 that can include Service GPRS Support Nodes (SGSN) such as SGSN 912 and 914. Each SGSN may be connected to an internal packet network 920 through which a SGSN 912, 914, etc. may route data packets to and from a plurality of gateway GPRS support nodes (GGSN) 922, 924, 926, etc. As illustrated, SGSN 914 and GGSNs 922, 924, and 926 may be part of internal packet network 920. Gateway GPRS serving nodes 922, 924 and 926 may provide an interface to external Internet Protocol (IP) networks, such as Public Land Mobile Network (PLMN) 950, corporate intranets 940, or Fixed-End System (FES) or the public Internet 930. As illustrated, subscriber corporate network 940 may be connected to GGSN 924 via firewall 932; and PLMN 950 may be connected to GGSN 924 via boarder gateway router 934. The Remote Authentication Dial-In User Service (RADIUS) server 942 may be used for caller authentication when a user of a mobile cellular device calls corporate network 940.

Generally, there can be four different cell sizes in a GSM network, referred to as macro, micro, pico, and umbrella cells. The coverage area of each cell is different in different environments. Macro cells may be regarded as cells in which the base station antenna is installed in a mast or a building above average roof top level. Micro cells are cells whose antenna height is under average roof top level. Micro-cells may be typically used in urban areas. Pico cells are small cells having a diameter of a few dozen meters. Pico cells may be used mainly indoors. On the other hand, umbrella cells may be used to cover shadowed regions of smaller cells and fill in gaps in coverage between those cells.

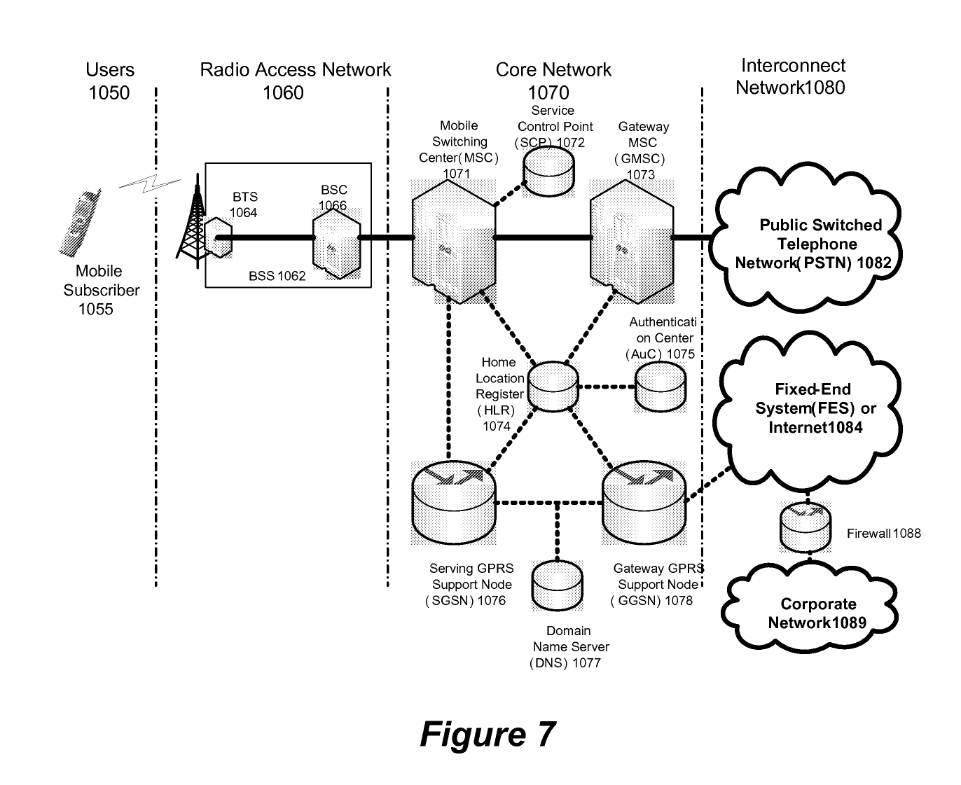

FIG. 7 illustrates an architecture of a typical GPRS network segmented into four groups: users 1050, radio access network 1060, core network 1070, and interconnect network 1080. Users 1050 may comprise a plurality of end users (though only mobile subscriber 1055 is shown in FIG. 7). In an example embodiment, the device depicted as mobile subscriber 1055 may comprise device 102 and/or device 104. Radio access network 1060 comprises a plurality of base station subsystems such as BSSs 1062, which include BTSs 1064 and BSCs 1066. Core network 1070 comprises a host of various network elements. As illustrated here, core network 1070 may comprise Mobile Switching Center (MSC) 1071, Service Control Point (SCP) 1072, gateway MSC 1073, SGSN 1076, Home Location Register (HLR) 1074, Authentication Center (AuC) 1075, Domain Name Server (DNS) 1077, and GGSN 1078. Interconnect network 1080 may also comprise a host of various networks and other network elements. As illustrated in FIG. 7, interconnect network 1080 comprises Public Switched Telephone Network (PSTN) 1082, Fixed-End System (FES) or Internet 1084, firewall 1088, and Corporate Network 1089.

A mobile switching center may be connected to a large number of base station controllers. At MSC 1071, for instance, depending on the type of traffic, the traffic may be separated in that voice may be sent to Public Switched Telephone Network (PSTN) 1082 through Gateway MSC (GMSC) 1073, and/or data may be sent to SGSN 1076, which then sends the data traffic to GGSN 1078 for further forwarding.

When MSC 1071 receives call traffic, for example, from BSC 1066, it may send a query to a database hosted by SCP 1072. The SCP 1072 may process the request and may issue a response to MSC 1071 so that it may continue call processing as appropriate.

The HLR 1074 may be a centralized database for users to register to the GPRS network. HLR 1074 may store static information about the subscribers such as the International Mobile Subscriber Identity (IMSI), subscribed services, and a key for authenticating the subscriber. HLR 1074 may also store dynamic subscriber information such as the current location of the mobile subscriber. HLR 1074 may also serve to intercept and determine the validity of destination numbers in messages sent from a device, such as mobile subscriber 1055, as described herein. Associated with HLR 1074 may be AuC 1075. AuC 1075 may be a database that contains the algorithms for authenticating subscribers and may include the associated keys for encryption to safeguard the user input for authentication.

In the following, depending on context, the term “mobile subscriber” sometimes refers to the end user and sometimes to the actual portable device, such as device 102, used by an end user of the mobile cellular service. When a mobile subscriber turns on his or her mobile device, the mobile device may go through an attach process by which the mobile device attaches to an SGSN of the GPRS network. In FIG. 7, when mobile subscriber 1055 initiates the attach process by turning on the network capabilities of the mobile device, an attach request may be sent by mobile subscriber 1055 to SGSN 1076. The SGSN 1076 queries another SGSN, to which mobile subscriber 1055 was attached before, for the identity of mobile subscriber 1055. Upon receiving the identity of mobile subscriber 1055 from the other SGSN, SGSN 1076 may request more information from mobile subscriber 1055. This information may be used to authenticate mobile subscriber 1055 to SGSN 1076 by HLR 1074. Once verified, SGSN 1076 sends a location update to HLR 1074 indicating the change of location to a new SGSN, in this case SGSN 1076. HLR 1074 may notify the old SGSN, to which mobile subscriber 1055 was attached before, to cancel the location process for mobile subscriber 1055. HLR 1074 may then notify SGSN 1076 that the location update has been performed. At this time, SGSN 1076 sends an Attach Accept message to mobile subscriber 1055, which in turn sends an Attach Complete message to SGSN 1076.

After attaching itself with the network, mobile subscriber 1055 may then go through the authentication process. In the authentication process, SGSN 1076 may send the authentication information to HLR 1074, which may send information back to SGSN 1076 based on the user profile that was part of the user's initial setup. The SGSN 1076 may then send a request for authentication and ciphering to mobile subscriber 1055. The mobile subscriber 1055 may use an algorithm to send the user identification (ID) and password to SGSN 1076. The SGSN 1076 may use the same algorithm and compares the result. If a match occurs, SGSN 1076 authenticates mobile subscriber 1055.

Next, the mobile subscriber 1055 may establish a user session with the destination network, corporate network 1089, by going through a Packet Data Protocol (PDP) activation process. Briefly, in the process, mobile subscriber 1055 may request access to the Access Point Name (APN), for example, UPS.com, and SGSN 1076 may receive the activation request from mobile subscriber 1055. SGSN 1076 may then initiate a Domain Name Service (DNS) query to learn which GGSN node has access to the UPS.com APN. The DNS query may be sent to the DNS server within the core network 1070, such as DNS 1077, which may be provisioned to map to one or more GGSN nodes in the core network 1070. Based on the APN, the mapped GGSN 1078 can access the requested corporate network 1089. The SGSN 1076 may then send to GGSN 1078 a Create Packet Data Protocol (PDP) Context Request message that contains necessary information. The GGSN 1078 may send a Create PDP Context Response message to SGSN 1076, which may then send an Activate PDP Context Accept message to mobile subscriber 1055.

Once activated, data packets of the call made by mobile subscriber 1055 may then go through radio access network 1060, core network 1070, and interconnect network 1080, in a particular fixed-end system, or Internet 1084 and firewall 1088, to reach corporate network 1089.

Thus, network elements that can invoke the functionality of message forwarding systems and methods such as those described herein can include but are not limited to Gateway GPRS Support Node tables, Fixed End System router tables, firewall systems, VPN tunnels, and any number of other network elements as required by the particular digital network.

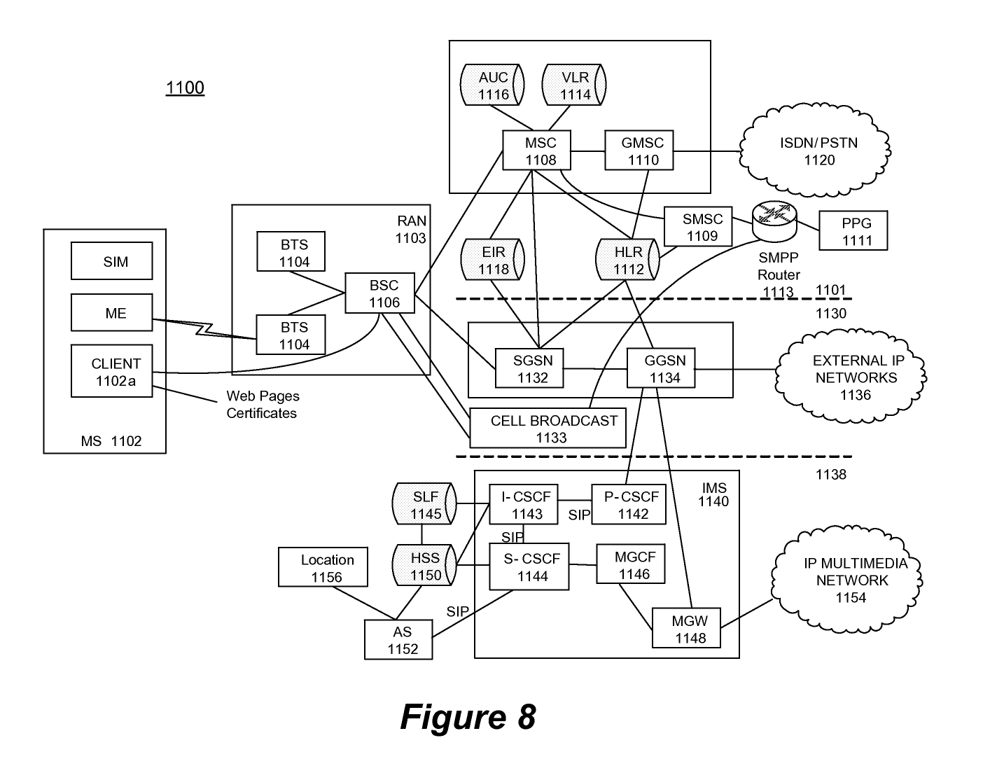

FIG. 8 illustrates another exemplary block diagram view of a GSM/GPRS/IP multimedia network architecture 1100 in which message forwarding systems such as those described herein can be incorporated. As illustrated, architecture 1100 of FIG. 8 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile telephone or a laptop computer (e.g., device 102) that is used by mobile subscribers, with a Subscriber identity Module (SIM). The SIM includes an International Mobile Subscriber Identity (IMSI), which is a unique identifier of a subscriber. The BTS 1104 may be physical equipment, such as a radio tower, that enables a radio interface to communicate with the MS. Each BTS may serve more than one MS. The BSC 1106 may manage radio resources, including the BTS. The BSC may be connected to several BTSs. The BSC and BTS components, in combination, are generally referred to as a base station (BSS) or radio access network (RAN) 1103.

The GSM core network 1101 may also include a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 may perform a switching function for the network. The MSC may also perform other functions, such as registration, authentication, location updating, handovers, and call routing. The GMSC 1110 may provide a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 is a database that may contain administrative information regarding each subscriber registered in a corresponding GSM network. Such information may also include address book data and/or message forwarding preferences for each subscriber. The HLR 1112 may also contain the current location of each MS. The VLR 1114 may be a database that contains selected administrative information from the HLR 1112. The VLR may contain information necessary for call control and provision of subscribed services for each MS currently located in a geographical area controlled by the VLR. The VLR may also contain address book data and/or message forwarding preferences for each subscriber. The HLR 1112 and the VLR 1114, together with the MSC 1108, may provide the call routing and roaming capabilities of GSM, as well as message forwarding functionality. The AuC 1116 may provide the parameters needed for authentication and encryption functions. Such parameters allow verification of a subscriber's identity. The EIR 1118 may store security-sensitive information about the mobile equipment.

A Short Message Service Center (SMSC) 1109 allows one-to-one short message service (SMS), or multimedia message service (MMS), messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 may be provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, short message service (SMS), and multimedia message service (MMS), the MS may first register with the network to indicate its current location by performing a location update and IMSI attach procedure. The MS 1102 may send a location update including its current location information to the MSC/VLR, via the BTS 1104 and the BSC 1106. The location information may then be sent to the MS's HLR. The HLR may be updated with the location information received from the MSC/VLR. The location update may also be performed when the MS moves to a new location area. Typically, the location update may be periodically performed to update the database as location updating events occur.

The GPRS network 1130 may be logically implemented on the GSM core network architecture by introducing two packet-switching network nodes, a serving GPRS support node (SGSN) 1132, a cell broadcast and a Gateway GPRS support node (GGSN) 1134. The SGSN 1132 may be at the same hierarchical level as the MSC 1108 in the GSM network. The SGSN may control the connection between the GPRS network and the MS 1102. The SGSN may also keep track of individual MS's locations and security functions and access controls.

A Cell Broadcast Center (CBC) 1133 may communicate cell broadcast messages that are typically delivered to multiple users in a specified area. Cell Broadcast is one-to-many geographically focused service. It enables messages to be communicated to multiple mobile telephone customers who are located within a given part of its network coverage area at the time the message is broadcast.

The GGSN 1134 may provide a gateway between the GPRS network and a public packet network (PDN) or other IP networks 1136. That is, the GGSN may provide interworking functionality with external networks, and set up a logical link to the MS through the SGSN. When packet-switched data leaves the GPRS network, it may be transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services may be used in parallel. The MS may operate in one three classes: class A, class B, and class C. A class A MS may attach to the network for both GPRS services and GSM services simultaneously. A class A MS may also support simultaneous operation of GPRS services and GSM services. For example, class A mobiles may receive GSM voice/data/SMS calls and GPRS data calls at the same time.

A class B MS may attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1130 may be designed to operate in three network operation modes (NOM1, NOM2 and NOM3). A network operation mode of a GPRS network may be indicated by a parameter in system information messages transmitted within a cell. The system information messages may direct a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while receiving data and vice versa.

The IP multimedia network 1138 was introduced with 3GPP Release 5, and may include an IP multimedia subsystem (IMS) 1140 to provide rich multimedia services to end users. A representative set of the network entities within the IMS 1140 are a call/session control function (CSCF), a media gateway control function (MGCF) 1146, a media gateway (MGW) 1148, and a master subscriber database, called a home subscriber server (HSS) 1150. The HSS 1150 may be common to the GSM core network 1101, the GPRS network 1130 as well as the IP multimedia network 1138.

The IP multimedia system 1140 may be built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 may forward session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

The I-CSCF 1143 forms an entrance to a home network and hides the inner topology of the home network from other networks and provides flexibility for selecting an S-CSCF. The I-CSCF 1143 may contact a subscriber location function (SLF) 1145 to determine which HSS 1150 to use for the particular subscriber, if multiple HSSs 1150 are present. The S-CSCF 1144 may perform the session control services for the MS 1102. This includes routing originating sessions to external networks and routing terminating sessions to visited networks. The S-CSCF 1144 may also decide whether an application server (AS) 1152 is required to receive information on an incoming SIP session request to ensure appropriate service handling. This decision is based on information received from the HSS 1150 (or other sources, such as an application server 1152). The AS 1152 may also communicate to a location server 1156 (e.g., a Gateway Mobile Location Center (GMLC)) that provides a position (e.g., latitude/longitude coordinates) of the MS 1102.

The HSS 1150 may contain a subscriber profile and keep track of which core network node is currently handling the subscriber. It may also support subscriber authentication and authorization functions (AAA). In networks with more than one HSS 1150, a subscriber location function provides information on the HSS 1150 that contains the profile of a given subscriber.

The MGCF 1146 may provide interworking functionality between SIP session control signaling from the IMS 1140 and ISUP/BICC call control signaling from the external GSTN networks (not shown.) It may also control the media gateway (MGW) 1148 that provides user-plane interworking functionality (e.g., converting between AMR- and PCM-coded voice.) The MGW 1148 may also communicate with other IP multimedia networks 1154.

Push to Talk over Cellular (PoC) capable mobile telephones may register with the wireless network when the telephones are in a predefined area (e.g., job site, etc.) When the mobile telephones leave the area, they may register with the network in their new location as being outside the predefined area. This registration, however, does not indicate the actual physical location of the mobile telephones outside the pre-defined area.

While example embodiments of message forwarding systems and methods such as those described herein have been described in connection with various computing devices/processors, the underlying concepts can be applied to any computing device, processor, or system capable of implementing the message forwarding systems and methods described. The various techniques described herein can be implemented in connection with hardware or software or, where appropriate, with a combination of both. Thus, the methods and apparatuses for the message forwarding systems and methods, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for a message forwarding system. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems for message forwarding as described herein can also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus a message forwarding system. When implemented on a general-purpose processor, the program code combines with the processor to provide a unique apparatus that operates to invoke the functionality of a message forwarding system. Additionally, any storage techniques used in connection with a message forwarding system can invariably be a combination of hardware and software.

While the message forwarding systems and methods have been described in connection with the various embodiments of the various figures, it is to be understood that other similar embodiments can be used or modifications and additions can be made to the described embodiments for performing the same function message forwarding without deviating from the described systems and methods. For example, one skilled in the art will recognize that a message forwarding system as described in the present application may apply to any environment, whether wired or wireless, and may be applied to any number of such devices connected via a communications network and interacting across the network. Therefore, message forwarding systems such as those described herein should not be limited to any single embodiment, but rather should be construed in breadth and scope in accordance with the appended claims.

Other applications for this type of system may exist in areas such as location-based services or in other sectors of industry that transport people who are in need of data and voice communication.

What is claimed:

1. A method for forwarding a message, comprising:
detecting a selection of a recipient number for the message on a mobile device;
determining that the recipient number is associated with a device that does not support messaging;
determining an alternate recipient number; and
transmitting the message to the alternate recipient number.

2. The method of claim 1, wherein determining the alternate recipient number comprises determining that a potential recipient number associated with the recipient number is associated with a device that supports messaging, and designating the potential recipient number as the alternate recipient number.

3. The method of claim 1, wherein determining the alternate recipient number comprises determining a recipient associated with the recipient number, determining a potential recipient number associated with the recipient, determining that the potential recipient number is associated with a device that supports messaging, and designating the potential recipient number as the alternate recipient number.

4. The method of claim 1, wherein detecting the selection of the recipient number comprises detecting a selection of a telephone number in an address book.

5. The method of claim 1, wherein detecting the selection of the recipient number comprises detecting the selection of a name in an address book.

6. The method of claim 5, further comprising determining a default telephone number associated with the name.

7. The method of claim 1, wherein determining the alternate recipient number comprises determining that a potential recipient number associated with the recipient number is designated as a default messaging number, and designating the default messaging number as the alternate recipient number.

8. A system for forwarding a message on a first communications network, comprising:
a receiver that receives the message transmitted from a mobile device, the message comprising a recipient number;
a processor that determines that the recipient number is associated with a device that does not support messaging and determines an alternate recipient number; and
a transmitter that transmits the message to the alternate recipient number.

9. The system of claim 8, wherein the processor determines that the recipient number is associated with the device that does not support messaging by determining that the recipient number is associated with a land line telephone.

10. The system of claim 8, wherein the processor determines the alternate recipient number by determining that a potential recipient number associated with the recipient number is associated with a recipient device capable of receiving messages, and designates the potential recipient number as the alternate recipient number.

11. The system of claim 10, wherein the potential recipient number is a number configured to receive messages at a request of a recipient.

12. The system of claim 11, wherein the potential recipient number is provided to the recipient by a second communications network.

13. A system for forwarding a message on a first communications network, comprising:
a receiver that receives the message transmitted from a mobile device, the message comprising a recipient number;
a processor that determines that the recipient number is associated with a device that does not support messaging and determines that no alternate recipient number is associated with a device that supports messaging; and
a transmitter that transmits the message using an alternate messaging means.

14. The system of claim 13, wherein the alternate messaging means is email.

15. The system of claim 13, wherein the alternate messaging means is voice telephony.

16. A mobile device configured to transmit and receive messages, comprising:
a transmitter that transmits a first message to a recipient number;
a receiver that receives a failure message, the failure message indicating that the first message was not deliverable to the recipient number;
a processor that determines an alternate recipient number and instructs the transmitter to transmit a second message to the alternate recipient number.

17. The mobile device of claim 16, wherein contents of the first message and the second message are identical.

18. The mobile device of claim 16, wherein the processor determines the alternate recipient number by determining a recipient associated with the recipient number, determining a potential alternate recipient number associated with the recipient, and designating the potential alternate recipient number as the alternate recipient number.

19. The mobile device of claim 18, wherein determining the potential alternate recipient number associated with the recipient comprises determining that the potential alternate recipient number is associated with a device that supports messaging.

20. The mobile device of claim 16, wherein the processor determines the alternate recipient number by determining that a recipient is associated with the recipient number, determining that at least two potential alternate recipient numbers are associated with the recipient, randomly selecting a first potential alternate recipient number from the at least two potential alternate recipient numbers, and designating the first potential alternate recipient number as the alternate recipient number.
